(19) United States
(12) Patent Application Publication
(10) Pub. No.: US 2005/0067801 A1
(43) Pub. Date: Mar. 31, 2005

(54) Steerable trolleys

(76) Inventor: Alaister Copland, Poole (GB)

Correspondence Address: JOHN V STEWART, 1308 HENRY BALCH DRIVE, ORLANDO, FL, 32810, US

(21) Appl. No.: 10/496,910

(22) PCT Filed: Nov. 27, 2002
(86) PCT No.: PCT/GB02/05369

(30) Foreign Application Priority Data
Nov. 29, 2001 (GB) 0128535.2

(51) Int. Cl. B62D 39/00

(52) U.S. Cl. 280/33.991

(57) ABSTRACT

As is conventional, a steerable trolley (10), such as a supermarket trolley, has a pair of front wheels (16, 18), a pair of rear wheels (20, 22) and a handle adjacent its rear by which a user can push the trolley forwards. The rear wheels have a wider track (R) than the track (F) of the front wheels, and each of the wheels is mounted to the body as a trailing castor. In order to improve the ease with which the trolley can be cornered, at least one of the wheels (and preferably each of the wheels) is mounted to the body so that the height at which that wheel supports the body above the ground is dependent on the trailing angle of that wheel such that when the trolley is pushed forwards in a turn the weight supported by the front wheel on the inside of the turn increases. This can be simply achieved by providing the rear wheels with negative camber (<i>r</i>) and the front wheels with positive camber (<i>f</i>). Because of this weight transfer to the inside front wheel, the frictional drag at that wheel increases, and this has a tendency to pull the trolley into the turn.

This invention relates to steerable trolleys and to methods of manufacture and modification of such trolleys.

The invention was originally conceived in relation to supermarket shopping trolleys (or “carts” in American-English), but it is applicable to other types and uses of steerable trolley.

More specifically, a first aspect of the invention relates to a steerable trolley of the general type comprising a body (which may take the form of a frame and wire basket), a pair of front wheels and a pair of rear wheels adjacent the front and the rear, respectively, of the body for running on the ground, and a handle adjacent the rear of the body by which a user can push the trolley forwards, wherein the rear wheels have a wider track than the front wheels, and wherein each of the wheels is mounted to the body for swivelling as a trailing castor about a respective castor-swivel axis.

Such trolleys are commonplace and greatly facilitate supermarket shopping. The trolley is designed primarily to be pushed, rather than pulled, so that the user can see where they and the trolley are going. Trailing castors are provided for all four wheels for maximum manoeuvrability. The front track is narrower than the rear track (and the trolley has other features) so that a plurality of such trolleys can be stacked in a line when not in use.

On level ground, it is usually easy to push such a trolley in a straight line. However, especially when the trolley is heavily laden, it can be difficult to push the trolley in a turn or across a slope with any degree of control. Although the user may have reasonable control over the direction of motion of the rear of the trolley, exercising control over the direction of motion of the front of the trolley can entail the user applying a large torque (about a vertical axis) to the handle of the trolley. Furthermore, these trolleys are prone to running downhill out of control when left parked on a slope.

Many proposals have been made in the past to improve the controllability of the conventional supermarket trolley, especially when performing a turn.

It is known to provide brakes that can be independently applied to the two sides of the trolley. However, this adds significantly to the complication of the trolley, and production and maintenance costs are increased. Furthermore, correct operation of the brakes requires user skill, and the brakes waste energy that the user has put into the trolley.

Patent document GB-A-2339556 describes a trolley in which the rear wheels have vertical resilient suspension. The intention is that, to assist in, say, a right turn, the user pushes down on the right-hand end of the handle. This reduces the frictional drag of the left front wheel, and so the trolley tends to swing to the right. Again, correct operation requires user skill. Furthermore, pushing down sufficiently on the handle would be awkward, especially for a short user, and heavy loads and unequal load distribution in the trolley would greatly upset its effectiveness.

Other examples of prior art depend on the replacement of swivelling castors with non-swivelling wheels at the rear or front of the trolley, or the addition to non-swivelling castors to the centre of the trolley. While these all help to exercise a degree of control over the trolley, they each introduce their own particular handling problems while sharing a severe reduction in overall manoeuvrability.

Yet other examples employ swivel-limiting devices at the castors to help maintain the trolley's straight line progress. However, much of a trolley's life is spent not going straight but in turning corners or avoiding obstacles and, as these devices all rely on some form of cam, follower and fixed-rate spring, any assistance they provide while turning soon diminishes to an insignificant amount as the weight in the trolley increases.

Patent document WO-A-96/29228 describes a trolley in which the front and rear wheels are interlinked so that when, say, the right rear wheel swivels in one direction, the right front wheel swivels by an equal amount in the opposite direction. This naturally make it easier to turn the trolley. However, again, this adds significantly to the complication of the trolley, and production and maintenance costs are increased.

The aim of the first aspect of the invention is to improve the controllability of trolleys of the general type described above in most, if not all, situations in which the trolley normally operates, irrespective of the load or its distribution within the trolley, preferably in a very simple, inexpensive and maintenance-free manner, without the user wasting energy or needing to learn new trolley-pushing skills, and without reducing the traditional trolley's highly-valued, overall manoeuvrability.

The trolley of the first aspect of the invention is characterised in that at least one of the wheels is mounted to the body so that the height at which that wheel supports the body above the ground is dependent on the trailing angle of that wheel such that when the trolley is pushed forwards in a turn the weight supported by the front wheel on the inside of the turn increases. Because of this weight transfer to the inside front wheel, the frictional drag at that wheel increases, and this has a tendency to pull the trolley into the turn.

The height at which said one wheel supports the body above the ground (a) preferably decreases as the trailing angle of that wheel increases from zero on the inside of a turn, (b) preferably increases as the trailing angle of that wheel increases from zero on the outside of a turn, and (c) more preferably does both. Preferably, the height at which said one wheel supports the body above the ground changes progressively with changes in the trailing angle of that wheel.

(In this specification, a trailing angle of zero refers to the castor orientation when the trolley is pushed forwards in a straight line.)

Preferably, at least one of the rear wheels is so mounted to the body. For example, the right rear wheel may be arranged so that the height at which it supports the body above the ground decreases as the wheel swivels anti-clockwise (as viewed from above) from a zero trailing angle and increases as the wheel swivels clockwise (as viewed from above) from a zero trailing angle. During a forward right turn (i.e. with the right wheels on the inside of the turn), the support height of the right rear wheel decreases and, because the front track of the trolley is narrower than the rear track, less of the weight is borne by the left front wheel and therefore more of the weight is borne by the right front wheel. Conversely, during a forward left turn (i.e. with the right wheels on the outside of the turn), the support height of the right rear wheel increases so that more of the weight is borne by the left front wheel.

In the case where at least one of the rear wheels is so mounted to the body, in a preferred embodiment, the castor-swivel axis of said one rear wheel is inclined in an upwards direction towards the vertical longitudinal centre plane of the trolley (i.e. the rear wheel has negative camber). This is a particularly simple way of implementing the invention. In this case, the angle of inclination is preferably in the range of 2° to 6° (i.e. a rear wheel camber angle of −2° to −6°). In an alternative embodiment, said one rear wheel is mounted to the body by a cam and follower arrangement.

Preferably, both of the rear wheels are so mounted to the body, in which case the height variation features of the rear wheels are preferably mutually symmetrical. This has the advantage that, when the trolley is being pushed straight ahead, any tendency of one of the rear wheels to turn the trolley in one direction is counterbalanced by the tendency of the other rear wheel to turn the trolley in opposite direction, providing the rear of the trolley with good directional stability on level ground and when crossing slopes and providing good stability when parked.

Alternatively, or more preferably additionally, at least one of the front wheels is mounted to the body so that the height at which it supports the body above the ground is dependent on its trailing angle. For example, the right front wheel may be arranged so that the height at which it supports the body above the ground decreases as the wheel swivels clockwise (as viewed from above) from a zero trailing angle and increases as the wheel swivels anti-clockwise (as viewed from above) from a zero trailing angle. Accordingly, during a forward right turn (i.e. with the right wheels on the inside of the turn), because more of the weight is borne by the right front wheel, the right front wheel tends to swivel clockwise (as viewed from above), so assisting in pulling the front of the trolley into the turn. Conversely, during a forward left turn (i.e. with the right wheels on the outside of the turn), because less of the weight is borne by the right front wheel, the right front wheel has less of a tendency to swivel clockwise (as viewed from above), so that it does not pull the front of the trolley into a right turn.

In the case where at least one of the front wheels is so mounted to the body, in a preferred embodiment, the castor-swivel axis of said one front wheel is inclined in an upwards direction away from the vertical longitudinal centre plane of the trolley (i.e. the front wheel has positive camber). Again, this is a particularly simple way of implementing the invention. In this case, the angle of inclination is preferably in the range of 1° to 3° (i.e. a front wheel camber angle of +1° to +3°). In an alternative embodiment, said one front wheel is mounted to the body by a cam and follower arrangement.

Preferably, both of the front wheels are so mounted to the body. Again, in this case the height variation features of the front wheels are preferably mutually symmetrical. This has the advantage that, when the trolley is being pushed straight ahead, any tendency of one of the front wheels to turn the trolley in one direction is counterbalanced by the tendency of the other front wheel to turn the trolley in opposite direction, providing the front of the trolley with good directional stability on level ground and when crossing slopes and providing good stability when parked.

Preferably, at least one of the wheels, and more preferably each of the wheels, has a castor angle (as distinct from a castor offset) of substantially zero, more preferably not more than ±2°, even more preferably not more than ±1°, and ideally more-or-less 0°.

Similarly to a conventional trolley, each wheel may be attached for swivelling to the body at a mounting point by a tubular king-pin, around which a bearing is arranged to permit the swivelling, and through which a fixing bolt passes for attaching to the mounting point.

In the embodiments that have an inclined castor-swivel axis, the axes of the fixing bolt and king-pin may be co-axially inclined to provide the inclined castor-swivel axis. A newly-manufactured trolley may therefore have the inclined castor-swivel axis designed into it, or an existing trolley may have its body or mounting point intentionally bent so as to provide the inclined castor-swivel axis.

Alternatively, the fixing bolt may be nominally vertical, as is conventional, but the king-pin axis may be inclined to the fixing bolt axis to provide the inclination of the castor-swivel axis. The king-pin axis is preferably so inclined by the use of at least one wedged shim and more preferably by a pair of wedged shims, one between the king-pin and the mounting point and the other between the king-pin and the head of the fixing bolt. A conventional trolley may be simply modified to incorporate these latter features, and a second aspect of the invention relates to a method of trolley modification.

According to the second aspect of the invention, there is provided a method of modifying a steerable trolley of the type comprising a body, a pair of front wheels and a pair of rear wheels adjacent the front and the rear, respectively, of the body for running on the ground, and a handle adjacent the rear of the body by which a user can push the trolley forwards, wherein the rear wheels have a wider track than the front wheels, and wherein each of the wheels is attached at a mounting point to the body for swivelling as a trailing castor about a castor-swivel axis by a tubular king-pin, around which a bearing is arranged to permit the swivelling, and through which a nominally-vertical fixing bolt passes for attaching to the mounting point. The method of the second aspect of the invention is characterised by the step of intentionally inclining the axis of at least one of the king-pins relative to the axis of the respective fixing bolt to provide the respective castor-swivel axis with a predetermined inclination.

The inclining step preferably comprises fitting at least one wedged shim between the king-pin and the mounting point, and more preferably fitting a pair of wedged shims, one between the king-pin and mounting point and the other between the king-pin and the head of the fixing bolt.

According to the third aspect of the invention, there is provided a method of manufacture of a steerable trolley of the type comprising a body, a pair of front wheels and a pair of rear wheels adjacent the front and the rear, respectively, of the body for running on the ground, and a handle adjacent the rear of the body by which a user can push the trolley forwards, wherein the rear wheels have a wider track than the front wheels, and wherein each of the wheels is attached at a mounting point to the body for swivelling as a trailing castor about a castor-swivel axis by a tubular king-pin, around which a bearing is arranged to permit the swivelling, and through which a nominally-vertical fixing bolt passes for attaching to the mounting point. The method of the third aspect of the invention is characterised by the step of intentionally arranging at least one of the mounting points so that the axes of the respective king-pin and fixing bolt are inclined to provide the respective castor-swivel axis with a predetermined inclination.

Performance of the method of the second or third aspect of the invention preferably results in a trolley according to the first aspect of the invention.

Specific embodiments of the present invention will now be described, purely by way of example, with reference to the accompanying drawings, in which:

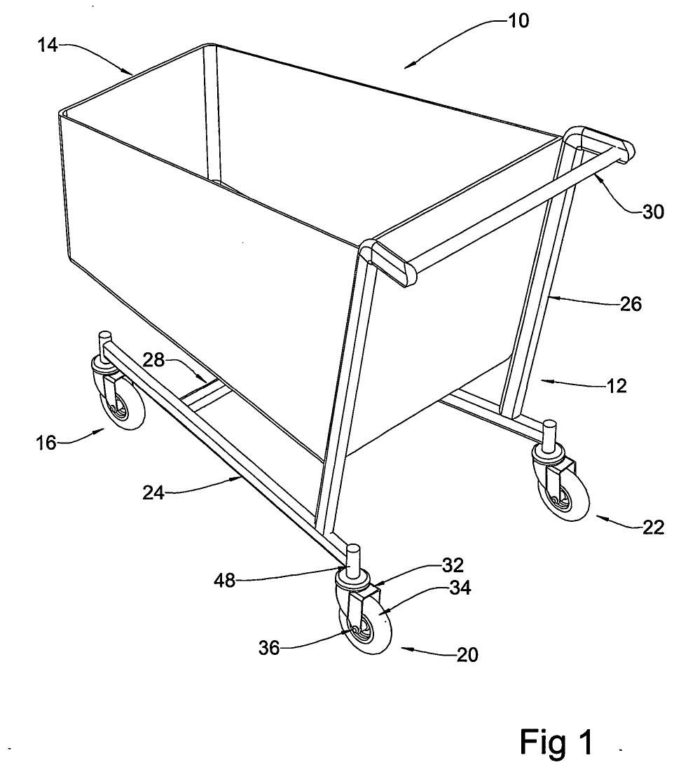

FIG. 1 is an isometric view of a shopping trolley with its castors in their straight-ahead positions;

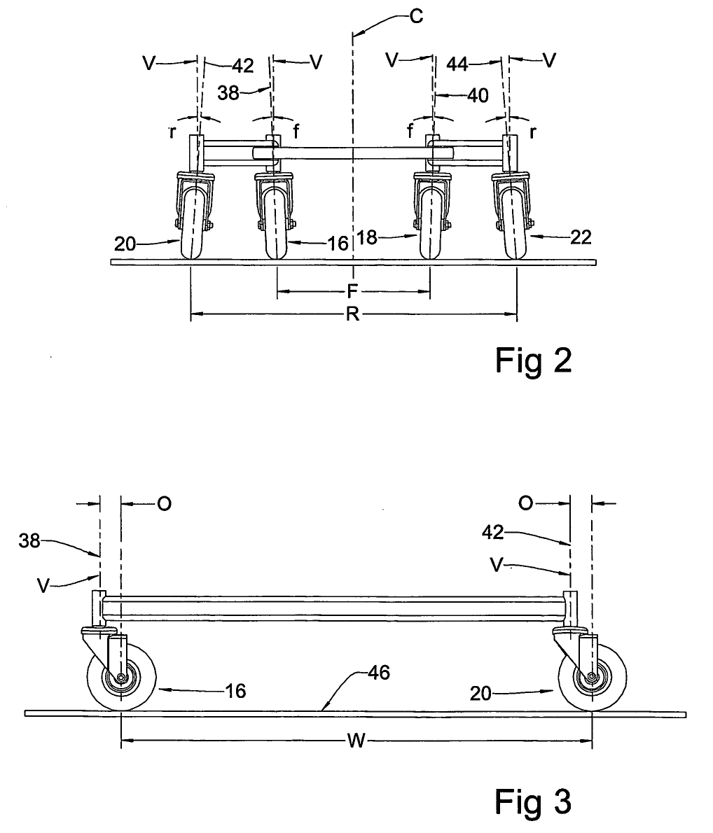

FIG. 2 is a rear view of the castors and part of the frame of the trolley of FIG. 1;

FIG. 3 is a side view of the castors and part of the frame of the trolley of FIG. 1;

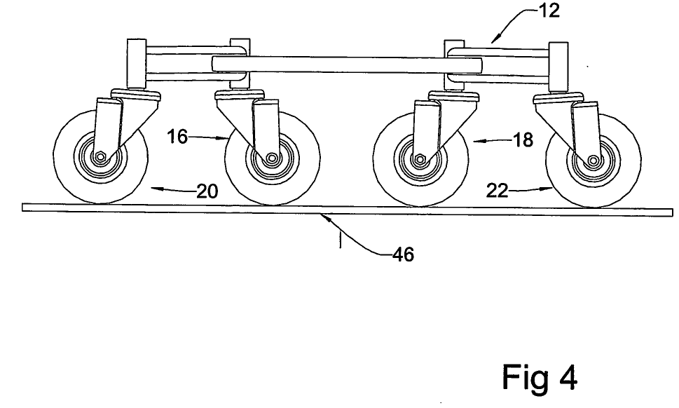

FIG. 4 is similar to FIG. 2, but with the castors in their settled positions;

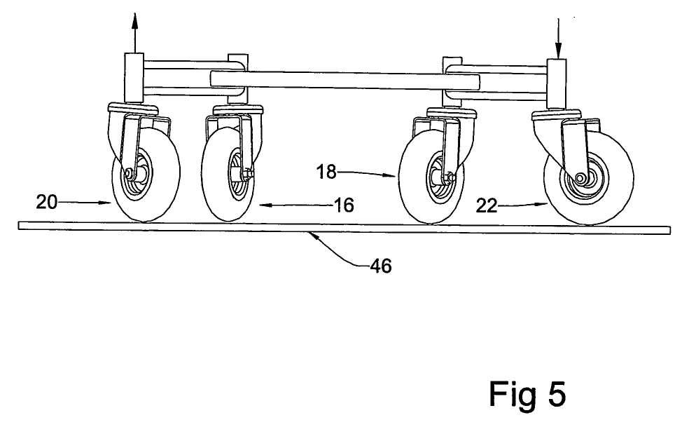

FIG. 5 is similar to FIG. 2, but with the castors positioned for a forward turn to the right;

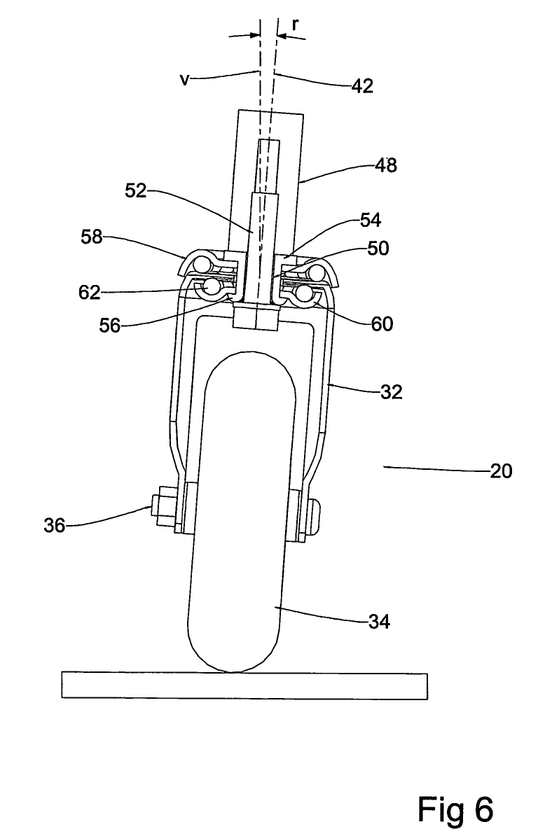

FIG. 6 is a rear cross-sectional view of a castor mounting arrangement that may be employed in the trolley of FIG. 1;

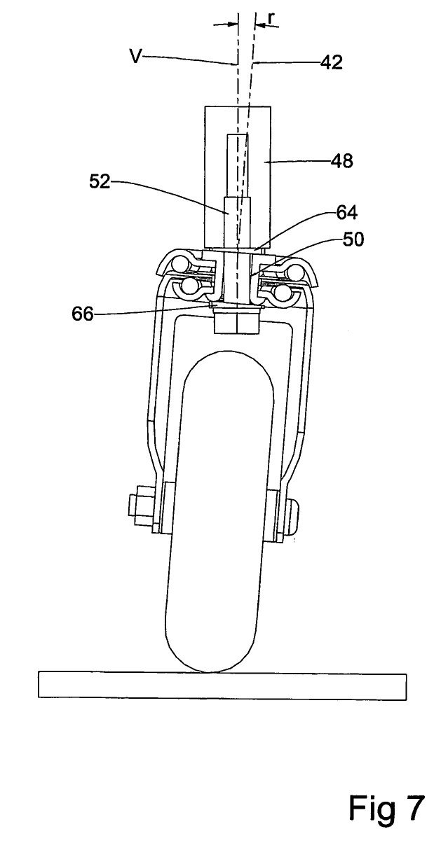

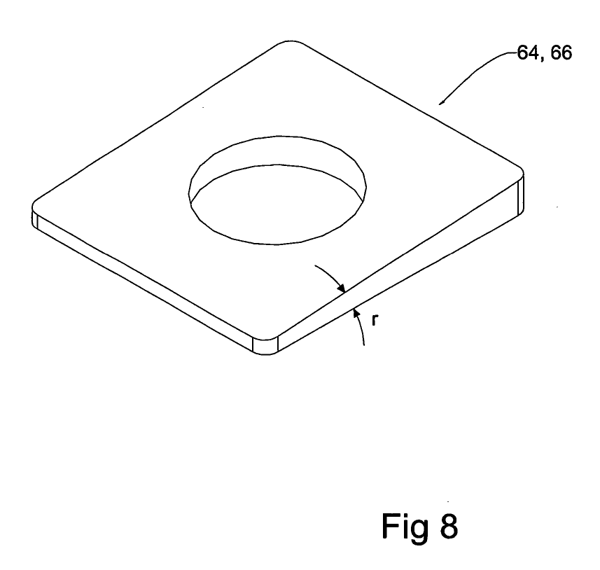

FIG. 7 is a rear cross-sectional view of a first modified castor mounting arrangement that is employed in the trolley of FIG. 1;

FIG. 8 is an isometric view of a wedged shim used in the arrangement of FIG. 7; and

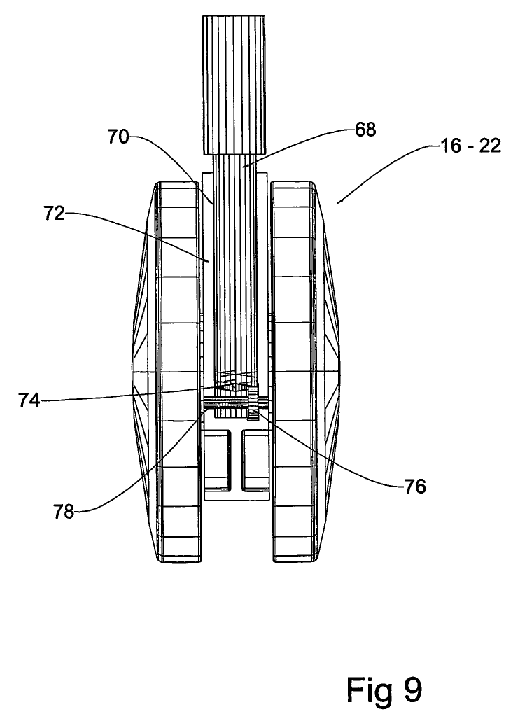

FIG. 9 is a rear cross-sectional view of a second modified castor mounting arrangement that may be employed in the trolley of FIG. 1.

Referring to FIGS. 1 to 5, a trolley 10 comprises a frame 12, a basket 14 and four castors 16,18,20,22. The frame 12 is formed of a pair of generally L-shaped side-frames 24,26 that are joined part-way along their bases by a cross-strut 28 and are joined at the tops of their uprights by a handle 30 for the trolley 10. Each castor 16,18,20,22 comprises a wheel carrier 32 that is mounted to a respective end of the base of one of the side-frames 24,26 for swivelling about a generally-vertical castor-swivel axis, and a wheel 34 that is rotatably mounted in the wheel carrier 32 on a horizontal spindle 36. Typically, the castor offset O (see FIG. 3) of the castors 16-22 may be in the range of 35 to 45 mm. The handle 30 is longer than the cross-strut 28 so that the track F (see FIG. 2) of the front castors 16,18 is less than the track R of the rear castors 20,22. Typically, the front track F may be about 250 to 300 mm, the rear track R may be about 500 to 600 mm, and the wheelbase W (see FIG. 3) may be 700 to 900 mm. As described in this paragraph, the trolley 10 is conventional.

Unlike a conventional trolley, in the trolley 10, the castor swivel axes are inclined to the vertical to provide non-zero camber. Specifically, and referring to FIG. 2, the front castors 16,18 have castor-swivel axes 38,40 that are inclined, in an upwards direction, away from the vertical longitudinal centre plane C of the trolley 10 at an angle f of about 1° to 3° (and preferably about 2°) to provide positive camber. By contrast, the rear castors 20,22 have castor-swivel axes 42,44 that are inclined, in an upwards direction, towards the vertical longitudinal centre plane C of the trolley 10 at an angle r of about 2° to 6° (and preferably about 4°) to provide negative camber. As viewed from the side (see FIG. 3), the castor-swivel axes 38-44 are generally vertical. In other words, the castors 16-22 have a castor angle (as opposed to a castor offset) of substantially zero.

It will therefore be appreciated that, when the trolley 10 is stationary on horizontal ground 46 and the castors 16-22 are settled, they adopt the positions shown in FIG. 4, i.e. with the front castors 16,18 trailing inwardly towards each other, and the rear castors 20,22 trailing outwardly away from each other. In this position, the frame 12 is at its lowest height above the ground 46.

However, when the trolley 10 is pushed forwards in a straight line, the castors 16-22 swivel, due to the castor offset O, so that all of the castors 16-22 trail to the rear of the trolley 10, as shown in FIGS. 2 and 3. In this position, each castor 16-22 raises the portion of the frame 12 which it supports by an amount approximately equal to the castor offset O multiplied by the camber angle f or r (as measured in radians) of the respective castor-swivel axis 38-44. When being pushed in a straight line, there is a tendency for the front left castor 16 to urge the front of the trolley 10 to the left, but this is counterbalanced by the tendency for the front right castor 18 to urge the front of the trolley 10 to the right. There is also a tendency for the rear left castor 20 to urge the rear of the trolley 10 to the right, but this is counterbalanced by the tendency for the rear right castor 22 to urge the rear of the trolley 10 to the left.

While pushing the trolley 10 forwards, a user can turn the trolley 10, for example to the right, by applying more pushing force to the left-hand end of the handle 30 than to the right-hand end and/or by swinging the handle 30 to the left. This causes both rear castors 20,22 to swivel anti-clockwise (as viewed from above) relative to the frame 12 (see FIG. 5). Due to the negative camber of the rear castors 20,22, such swivelling of the rear castors 20,22 results in the rear left castor 20 raising its corner of the frame 12 slightly, and the rear right castor 22 lowering its corner of the frame slightly. Accordingly, the loads borne by the rear left castor 20 and the front right castor 18 increase, and the load borne by the front left castor 16 decreases. (Indeed, the front left castor 16 may even lose contact with the ground 46.) Due to the increased load on the front right castor 18, there is an increase in frictional drag at the front right castor 18, and this tends to swing the trolley 10 to the right, i.e. to pull the front of the trolley into the turn. Furthermore, due to the positive camber of the front right castor 18, the increased load on the front right castor 18 tends to swivel the front right castor 18 clockwise (as viewed from above), which also tends to pull the front of the trolley 10 into the turn. Accordingly, the front of the trolley 10 tends to steer into the turn dictated by the user pushing the handle 30 at the rear of the trolley.

It will, of course, be immediately appreciated that the opposite effect occurs when the user tries to turn the trolley 10 to the left. However, it may not be so readily appreciated that the above arrangement provides the desirable effect that the forces to assist steering and create directional stability, as provided by the non-zero camber angles f,r of the castors 16-22, increase in proportion to the load in the trolley 10. However, these forces do not prevent the trolley being manoeuvred in any direction at any time as dictated by the user.

In addition to the primary advantageous effect of the arrangement described above to facilitate steering of the trolley 10, there are a number of other advantageous effects.

The trolley 10 can be parked pointing up or down a gradient, and providing that the gradient is insufficient to cause otherwise, the tendency of the castors 16-22 to adopt the settled position shown in FIG. 4 (in which the castors 16-22 are trailing across the gradient) provides an automatic braking system for the trolley 10.

Furthermore, when traversing a slope, with a conventional trolley there is of course a tendency for the trolley to roll down the slope. The user can more easily prevent the rear, than the front, rolling downwards, and so there is a tendency for the trolley to turn into the slope. However, with the embodiment of the invention described above, the tendency of the castors 16-22 to turn to roll down the slope causes the rear downhill castor and the front uphill castor to raise their corners of the frame 12 and therefore accept more of the load. The increased load on those two castors produces torques tending to swivel those castors towards their straight-ahead positions, thus counteracting the previously described tendency of the trolley 10 to turn downhill.

The arrangement described above does have a drawback in that there is a tendency for the front of the trolley to be diverted by bumps in the ground. When a front castor 16,18 rides over a bump, it tends to swivel inwards and cause the trolley 10 to turn as a result. However, when under the control of a user, in a supermarket where the floor is smooth, and on a relatively smooth car park surface, this is hardly noticeable to the user. Furthermore, this effect does have the advantage that, if the trolley 10 is allowed to escape downhill, the tendency for the front castors 16,18 to be diverted may well turn the trolley 10 across the slope and bring it to a halt before it has gathered much speed. Moreover, this effect may have the advantage of dissuading shoppers from taking a trolley 10 from the area of the supermarket and its car park and attempting to push it across more undulatory ground.

FIG. 6 shows in greater detail the rear left castor 20 and one embodiment of its attachment to a mounting post 48 forming part of the frame 12. A tubular king-pin 50 is attached to the mounting post 48 by a bolt 52 extending through the king-pin 50 and screwed into the mounting post 48. The king-pin 50 has a pair of flanges 54,56, between which are sandwiched an upper bearing plate 58, the wheel carrier 32 and a lower bearing plate 60. The bearing plates 58,60 and wheel carrier 32 are formed with raceways that hold two sets of ball bearings 62. The fixing bolt 52, king-pin 50 and bearing plates 58,60 are therefore rigidly fixed to the mounting post 48, and the wheel carrier 32 can swivel, between the two sets of ball-bearings 62, about a castor-swivel axis defined by the coaxial axes of the king-pin 50 and fixing bolt 52. In a conventional trolley, these axes are vertical. However, in the embodiment shown in FIG. 6, all three of these axes 42 (or 38,40,44 for the other wheels) are inclined to the vertical V by the camber angle r (or f). This may be accomplished in a newly-manufactured trolley 10 by, for example, welding the mounting post 48 to the reminder of the frame 12 at the required camber angle, or in an existing trolley 10 by, for example, bending the frame 12 near the mounting post 48 so that the mounting post 48 is at the required camber angle.

In an alternative embodiment, as shown in FIG. 7, that is particularly, but not exclusively, intended for converting existing conventional trolleys to incorporate the invention, the mounting post 48 remains nominally vertical. However, a wedged shim 64 (as shown in FIG. 8) is fitted on the fixing bolt 52 between the upper end of the tubular king-pin 50 and the lower end of the mounting post 48, and a further wedged shim 66 is fitted on the fixing bolt 52 between the lower end of the tubular king-pin 50 and head of the fixing bolt 52. Each wedged shim 64,66 has its faces inclined with respect to each other by the required camber angle r (or f), and the shims 64,66 are oppositely oriented on the fixing bolt 52 to provide the axis of the king-pin 50 and therefore the castor-swivel axis 42 with the required amount and sign (positive or negative) of camber angle r (or f) and with substantially no castor angle.

In a further embodiment, as shown in FIG. 9, a type of castor 16-22 is employed in which a vertical king-pin 68 depends from the frame of the trolley and fits into a hole 70 in a body 72 of a twin wheeled castor so that the body 72 can swivel around the king-pin 68. The lower end of the king-pin 68 is formed with a downwardly-facing annular cam face 74, and the castor body 72 has a follower roller 76 that is mounted on a pin 78 extending transversely of the hole 70 for rotation about the axis of the roller 76 and that is engaged by the cam face 74 so that the depth of engagement of the king-pin 68 in the hole 70 is dependent on the trailing angle of the castor, for example in a single-cycle sinusoidal or triangular manner. The cam face 74 is oriented so that the greatest depth of engagement is provided when the castor is trailing sideways outwardly in the case of a rear castor 20,22, and when the castor is trailing sideways inwardly in the case of a front castor 16,18. This embodiment therefore uses a cam and follower arrangement 74,76, rather than non-zero camber angles, to achieve the desired effects.

It should be noted that the embodiments of the invention have been described above purely by way of example and that many modifications and developments may be made thereto within the scope of the present invention.

1. A steerable trolley (10) comprising a body (12,14), a pair of front wheels (16,18) and a pair of rear wheels (20,22) adjacent the front and the rear, respectively, of the body for running on the ground (46), and a handle (30) adjacent the rear of the body by which a user can push the trolley forwards, wherein the rear wheels have a wider track than the front wheels, and wherein each of the wheels is mounted to the body for swivelling as a trailing castor about a respective castor-swivel axis (38-44), characterised in that:
at least one of the rear wheels is mounted to the body so that the height at which that wheel supports the body above the ground is dependent on the trailing angle of that wheel such that when the trolley is pushed forwards in a turn the weight supported by the front wheel on the inside of the turn increases.

2. A trolley as claimed in claim 1, wherein the height at which said one rear wheel supports the body above the ground decreases as the trailing angle of that wheel increases from zero on the inside of a turn.

3. A trolley as claimed in claim 1, wherein the height at which said one rear wheel supports the body above the ground increases as the trailing angle of that wheel increases from zero on the outside of a turn.

4. A trolley as claimed in claim 1, wherein the height at which said one rear wheel supports the body above the ground changes progressively with changes in the trailing angle of that wheel.

5. (cancelled)

6. A trolley as claimed in claim 1, wherein the castor-swivel axis (42,44) of said one rear wheel is inclined in an upwards direction towards the vertical longitudinal centre plane (C) of the trolley.

7. A trolley as claimed in claim 6, wherein the angle of inclination (r) is in the range of 2° to 6°

8. A trolley as claimed in claim 1, wherein said one rear wheel is mounted to the body by a cam and follower arrangement (74,76).

9. A trolley as claimed in claim 1, wherein both of the rear wheels are so mounted to the body.

10. A trolley as claimed in claim 9, wherein the height variation features of the rear wheels are mutually symmetrical.

11. A trolley as claimed in claim 1, wherein at least one of the front wheels is mounted to the body so that the height at which that wheel supports the body above the ground is dependent on the trailing angle of that wheel.

12. A trolley as claimed in claim 11, wherein the castor-swivel axis (38,40) of said one front wheel is inclined in an upwards direction away from the vertical longitudinal centre plane of the trolley.

13. A trolley as claimed in claim 12, wherein the angle of inclination (f) is in the range of 1° to 3°.

14. A trolley as claimed in claim 11, wherein said one front wheel is mounted to the body by a cam and follower arrangement (74,76).

15. A trolley as claimed in claim 11, wherein both of the front wheels are so mounted to the body.

16. A trolley as claimed in claim 15, wherein the height variation features of the front wheels are mutually symmetrical.

17. A trolley as claimed in claim 1, wherein at least said one wheel has a castor angle of substantially zero.

18. A trolley as claimed in claim 1, wherein at least one of the wheels is attached for swivelling to the body at a mounting point (48) by a tubular king-pin (50), around which a bearing (58-62) is arranged to permit the swivelling, and through which a fixing bolt (52) passes for attaching to the mounting point.

19. A trolley as claimed in claim 18, wherein the castor-swivel axis (42,44) of at least said one wheel is inclined and the axes of the fixing bolt and king-pin are co-axially inclined to provide the inclined castor-swivel axis.

20. A trolley as claimed in claim 18, wherein the castor-swivel axis (42,44) of at least said one wheel is inclined, the fixing bolt is nominally vertical, and the king-pin axis is inclined to the fixing bolt axis to provide the inclination of the castor-swivel axis.

21. A trolley as claimed in claim 20, wherein the king-pin axis is so inclined by the use of at least one wedged shim (64).

22. A trolley as claimed in claim 20, wherein the king-pin axis is so inclined by the use of a pair of wedged shims (64,66), one between the king-pin and mounting point and the other between the king-pin and the head of the fixing bolt.

23. (Currently cancelled)

24. (Currently cancelled)

25. (Currently cancelled)

26. (Currently cancelled)

27. (Currently cancelled)
